(19) United States
(12) Patent Application Publication
(10) Pub. No.: US 2011/0099280 A1
(43) Pub. Date: Apr. 28, 2011

(54) SYSTEMS AND METHODS FOR SECURE ACCESS TO REMOTE NETWORKS UTILIZING WIRELESS NETWORKS

(76) Inventors: David THOMAS, Roswell, GA (US); Todd Nightingale, Atlanta, GA (US); Amit Sinha, Marlborough, MA (US); Vibhu Vivek, Fremont, CA (US)

(21) Appl. No.: 12/607,151

(22) Filed: Oct. 28, 2009

(51) Int. Cl. G06F 15/16

(52) U.S. Cl. 709/228

(57) ABSTRACT

The present disclosure provides secure connectivity to remote networks on demand without requiring an interactive logon at a wireless client. Specifically, the present invention utilizes a proxy in a wireless network, such as an Access Point (AP) or the like, to provide client access to a remote, hosted network external to the wireless network. The present invention utilizes existing wireless security protocols and other security mechanisms between the proxy and the remote, hosted network. In operation, a wireless network proxy responds to a wireless client that is seeking a remote, hosted network, such as through an association request. The wireless network proxy then serves as an intermediary between the remote, hosted network and the wireless client to enable secure end-to-end communication.

### FIELD OF THE INVENTION

The present invention relates generally to secure network access utilizing wireless networks. More particularly, the present invention relates to systems and methods to access remote hosted wireless networks securely through a local wireless network utilizing wireless security protocols that are extended by the wireless infrastructure devices from wireless clients to the remote hosted wireless network.

### BACKGROUND OF THE INVENTION

Establishing a secure connection with a remote network currently requires client software and/or web browser components on a device. For example, a virtual private network (VPN) is a computer network in which some of the links between nodes are carried by open connections or virtual circuits in some larger networks (such as the Internet), as opposed to running across a single private network. Referring to FIG. 1, a conventional secure network 10 is illustrated utilizing a VPN. VPNs require client software and the associated proper configuration on a client device 12. As described herein, the client device 12 includes any device configured with a network interface operable to transmit and receive data over a network including, but not limited to, laptops, desktop computers, smart phones, cell phones, music players, video game devices, personal digital assistants (PDAs), and the like. The VPN client software is used to identify a remote network or gateway 14 and establish a secure tunnel between the device 12 and the gateway 14. For example, the device 12 can be communicating via its network interface over the Internet 16, and the VPN can provide secure access to the gateway 14 through this Internet 16 connection and a firewall 17, such as providing secure access to a corporate network 18. For the simplest VPN connections, only a web browser is required. When a user needs to access a variety of applications or systems on the network 18, the VPN client becomes more complex. The VPN gateway 14 is hosted by the remote network and is responsible for authenticating users, decrypting data, and forwarding data to the internal network 18.

Using VPNs is a well established method of securely accessing remote networks; however, there are numerous disadvantages. The most relevant disadvantage is the requirement for VPN client software, a web browser, and/or web browser components and the need for users to understand how to properly configure and operate that software. VPN client software can include specific VPN software supplied by the VPN vendor, VPN software built into the operating system, a web browser, and/or web browser components. For simplicity sake, the term VPN client refers to any one or any combination of the aforementioned technologies.

VPN clients are notoriously difficult to configure, deploy, manage, and support. The specific type of VPN in use will dictate the level of difficulty. For instance, a Secure Socket Layer (SSL) VPN where users need access to only web applications is the simplest by far while a full tunnel VPN is the most complex. Regardless of the type of VPN implemented, companies can often quantify the significant expense of deploying VPN clients and would strongly prefer to avoid them altogether. Another significant issue with VPN clients is that they are often not available for every device that needs to gain access to the network. Vendors of VPN clients often support only the most prevalent types of devices such as laptops running Microsoft Windows (available from Microsoft Corporation of Redmond, Wash.). There is not always support for products with less penetration in the market. This is especially true as mobile and embedded devices proliferate, and as new operating systems are developed for such devices. For example, vendors of VPN clients cannot afford to build and test VPN client software for every model of cellular telephone.

Another disadvantage is that VPN client software in almost all cases requires an interactive logon. This process is time consuming at best and impossible at worst. End users must understand how to start the software, initiate a connection, and logon. Depending on the exact type of VPN and hardware in use, this process commonly takes between 15 seconds and 3 minutes. While this amount of time may seem minimal, it can present enough of a hassle to dissuade end users. More importantly, many of the devices that need access today and will need access in the future do not have full user interfaces and keyboards. On these devices, an interactive logon will be significantly harder or even impossible. For example, an embedded device with a fixed user interface and only five buttons can hardly be expected in a timely manner to start a VPN application and allow for the entry of a username and password.

### BRIEF SUMMARY OF THE INVENTION

In various exemplary embodiments, the present invention provides secure connectivity to remote networks on demand without requiring an interactive logon at a wireless client. Specifically, the present invention utilizes a proxy in a wireless network, such as an Access Point (AP) or the like, to provide client access to a remote, hosted network external to the wireless network. The present invention provides systems and methods by which standard wireless clients can establish a secure connection to a remote network through an untrusted local wireless proxy. Advantageously, the clients do not need to be modified or enhanced with security agents or software. The local wireless networks and network components do not need to be trusted with authentication or encryption credentials, and data is fully secure from the client to the remote network. The present invention utilizes existing wireless security protocols and other security mechanisms between the proxy and the remote, hosted network. In operation, a wireless network proxy responds to a wireless client that is seeking a remote, hosted network and encapsulates the secure wireless connection from the wireless client to the remote, hosted network. The wireless network proxy serves as an intermediary between the wireless network gateway and the wireless client to enable secure end-to-end communication between the client and the remote, hosted network.

In an exemplary embodiment of the present invention, a network includes a local wireless network including a wireless network proxy; a hosted network connected through an external network to the wireless network proxy; and a wireless client; wherein the wireless network proxy is configured to enable a secure connection from the wireless client to the hosted network providing access for the wireless client to the hosted network. The wireless client communicates to the hosted network through the secure connection including any of IEEE 802.11i, AES encryption, and IEEE 802.1x, WPA, WPA2, TKIP, and WEP. The wireless proxy, responsive to a request from the client, encapsulates security credentials of the client and sends them to the hosted network over the external network. The network further includes a lookup server connected to the wireless network proxy, wherein the lookup server includes a directory of a plurality of hosted networks including the hosted network. The network further includes a wireless network gateway in the hosted network; wherein the wireless network proxy serves as an intermediary between the wireless network gateway and the wireless client to enable the secure tunnel through the external network. The wireless network gateway is configured to authenticate the wireless client, decrypt data from the wireless client, and forward decrypted data to the hosted network. The wireless network gateway and the wireless network proxy are configured to gather statistics relates to the wireless client and the hosted network, and wherein the wireless network gateway and the wireless network proxy are further configured to update the statistics to a centralized accounting system. The wireless network gateway is configured to publish local services on the local wireless network through a secure connection. The secure connection includes encryption between the wireless client and the hosted network and with the wireless network proxy is unaware of keys associated with the encryption. The wireless client includes a device compliant to IEEE 802.11 protocols, and wherein the wireless client communicates normally on the local wireless network with the wireless network proxy and wireless network gateway forming the secure connection. The wireless network gateway includes a virtual access point and the wireless client associates with the virtual access point.

In another exemplary embodiment of the present invention, a wireless infrastructure device includes a radio connected to a local wireless network; a backhaul network interface connected to an external network; a processor; and a local interface communicatively coupling the radio, the backhaul network interface, and the processor; wherein the radio, the backhaul network interface, and the processor are collectively configured to: receive association requests from a wireless client, wherein the association requests include a request to access a remote network; and enable a secure connection through the backhaul network interface to the remote network such that the wireless client can securely access the remote network. The radio, the backhaul network interface, and the processor are further configured to look up the remote network through one of a look up server and a public domain name server. The radio, the backhaul network interface, and the processor are further configured to enable the secure transmission of data from the wireless client to a wireless network gateway in the remote network. The wireless network gateway is configured to receive the data from the wireless client and to authenticate the wireless client, decrypt data from the wireless client, and forward decrypted data to devices in the remote network. The radio, the backhaul network interface, and the processor are further configured to receive published local services from the wireless network gateway. The radio, the backhaul network interface, and the processor are further configured to gather statistics relates to the wireless client and the remote network.

In yet another exemplary embodiment of the present invention, a remote wireless access method includes in a wireless network, receiving an association request from a client including a request to access a hosted network; enabling a secure connection from the client to the hosted network; and acting as a proxy between the client and the hosted network to securely transmit data between the client and the hosted network. The remote wireless access method further includes looking up the hosted network responsive to the association request and prior to enabling the secure connection. The data received from the client over the wireless network is secure through a wireless network security mechanism and wherein the data in thereafter transmitted encapsulating the wireless network security mechanism to the hosted network.

### BRIEF DESCRIPTION OF THE DRAWINGS

The present invention is illustrated and described herein with reference to the various drawings, in which like reference numbers denote like method steps and/or system components, respectively, and in which:

FIG. 1 is a conventional secure network utilizing a VPN;

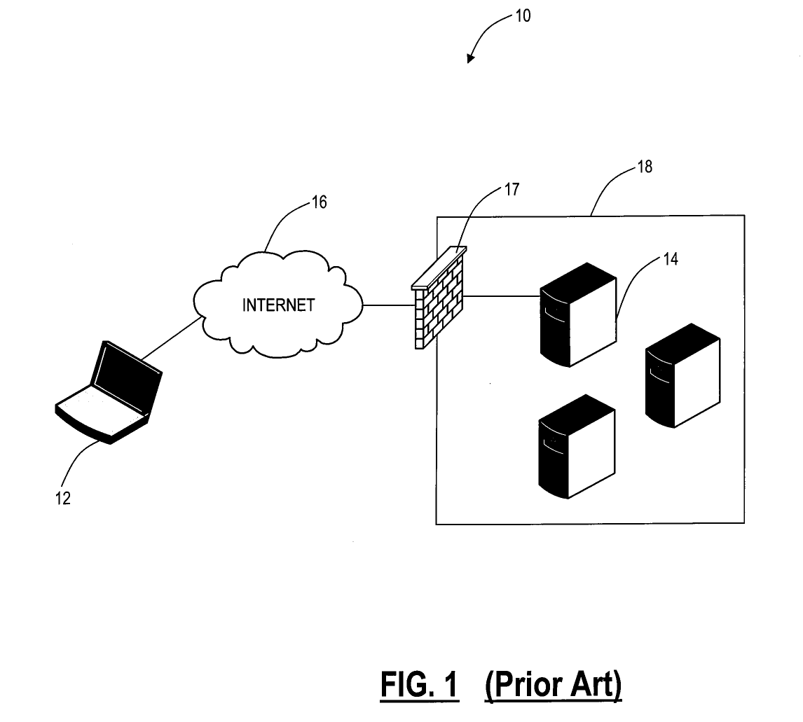

FIG. 2 is a network architecture of a wireless network that provides secure access to a remote network according to an exemplary embodiment of the present invention;

FIG. 3 is a flowchart of a wireless network access process for connecting a hosted wireless network from a remote wireless network according to an exemplary embodiment of the present invention;

FIG. 4 is a wireless infrastructure access device according to an exemplary embodiment of the present invention; and

FIG. 5 is a server according to an exemplary embodiment of the present invention.

### DETAILED DESCRIPTION OF THE INVENTION

In various exemplary embodiments, the present invention provides secure connectivity to remote networks on demand without requiring an interactive logon at a wireless client. Specifically, the present invention utilizes a proxy in a wireless network, such as an Access Point (AP) or the like, to provide client access to a remote, hosted network external to the wireless network. The present invention utilizes existing wireless security protocols and other security mechanisms between the proxy and the remote, hosted network. In operation, a wireless network proxy responds to a wireless client that is seeking a remote, hosted network to extend a secure wireless connection from the wireless client to the remote, hosted network. The wireless network proxy serves as an intermediary between the wireless network gateway and the wireless client to enable secure end-to-end communication between the client and the remote, hosted network. Advantageously, the wireless client is unaware of the underlying processes between the wireless network proxy and the remote, hosted network as it is transparent to the wireless client. In an exemplary embodiment, the present invention utilizes IEEE 802.11 and associated protocols, but the present invention can be utilized with other protocols. The present invention can generate aggregate usage statistics and logs per user per hosted network for billing or other purposes. Also, the present invention can allow access to both the local network and to multiple hosted networks on the same wireless network proxy.

Wireless Local Area Networks (WLANs) are generally defined in IEEE 802.11 standards and can operate over the unregulated 2.4 and 5 GHz frequency bands spectrum. WLAN vendors have committed to supporting a variety of standards such as IEEE 802.11a, 802.11b, 802.11g, 802.11i, 802.11n, and 802.1X. The various 802.11 standards developed by the IEEE are available for download via URL: standards.ieee.org/getieee802/802.11.html; these various standards are hereby incorporated by this reference herein. Most WLANs are operated solely for access to a single, private internal network and do not allow others to connect. Other WLANs, typically called hotspots, enable connectivity to the Internet after a cumbersome logon process to obtain payment information and the like. Wireless networks have one disadvantage compared to VPNs; namely they only operate in a secure manner in the immediate vicinity of a company's physical facility. The present invention enables wireless networks to be extended to remote locations removing VPNs as the only choice when connecting from remote locations. Also, the present invention uses the standard based security components already on the wireless client for authentication and encryption.

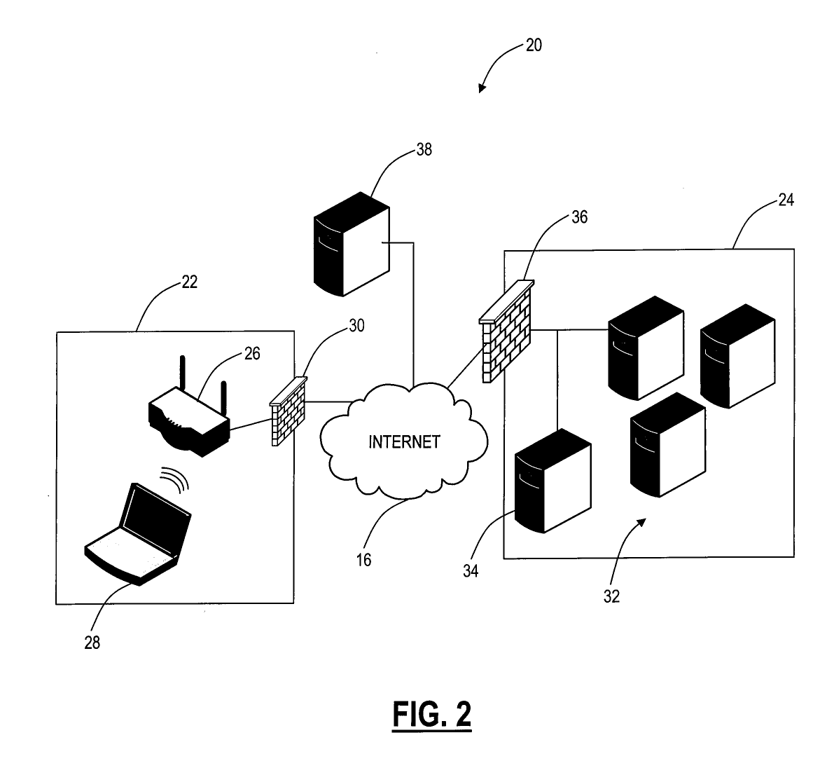

Referring to FIG. 2, a network architecture 20 is illustrated with a wireless network 22 that provides secure access to a remote network 24 according to an exemplary embodiment of the present invention. The wireless network 22 can be a WLAN operating according to the IEEE 802.11 protocols or the like. The present invention described herein utilizes IEEE 802.11 as an exemplary wireless network, but those of ordinary skill in the art will recognize the systems and methods of the present invention can be utilized with any wireless networking protocol. The wireless network 22 includes an Access Point (AP) 26 that provides wireless connectivity to a wireless client 28 (as well as multiple wireless clients 28). The AP 26 is an exemplary wireless network infrastructure product as described herein. The present invention also contemplates other wireless network infrastructure products such as wireless switches/controllers, thin APs, base stations, and the like. Collectively, the AP 26 and other wireless network infrastructure products are referred to herein as a wireless network proxy. The wireless client 28 can be a computer with a WLAN interface, a smart-phone, a personal digital assistant (PDA), a music player (e.g., mp3), a video gaming console, a portable video game device, a printer, a mobile unit with a wireless interface, or any other device configured with a wireless networking interface. The AP 26 includes a wireless networking interface (wireless transmitter/receiver) that allows the wireless client 28 to connect to the wireless network 22 utilizing Wi-Fi, Bluetooth, or other standards. The AP 26 also includes a backhaul connection that is configured to provide a connection from the wireless network 22 to an external network, such as the Internet 16. This backhaul connection can be a wired or a wireless connection, and the external network could be another network besides the Internet 16. In this example, the AP 26 connects to the Internet 16 through a firewall 30.

The remote network 24 includes a plurality of internal network devices 32 interconnected through various wired and/or wireless connections and a wireless network gateway 34. The remote network 24 is connected in this exemplary embodiment to the Internet 16 through a firewall 36. In the present invention, the remote network 24 is referred to herein as a hosted network. A hosted network is a network that advertises itself as remotely accessible. The wireless network gateway 34 is a device, e.g. computer, server, etc., on the remote network 24 that enables wireless network proxies, i.e. the AP 26 in FIG. 2, to provide connectivity for wireless clients 28 to the remote network 24. Wireless network proxies are device(s) operating at the wireless network 22 that enable wireless clients 28 to establish connectivity to hosted wireless networks, such as the remote network 24. The present invention provides systems and methods for the wireless client 28 to connect to the remote network 24 through the wireless network 22 without requiring VPN software, setup, and the like. The wireless network proxy can serve as an intermediary between the wireless network gateway 34 and the wireless client 28 which enables secure end-to-end tunnels to be established utilizing wireless security protocols from the client 28 to the gateway 34. Additionally, a lookup server 38 can be connected to any of the networks 22, 24, such as through the Internet 16, to provide lookup services for hosted wireless networks, e.g. the remote network 24 and other hosted networks. The lookup services can include a directory of available hosted wireless networks that can be accessed by the proxy, i.e. AP 26, to determine addressing of the remote network 24 responsive to a request from the client 28.

Wireless networks, e.g. networks 22, 24, manage to allow secure connectivity to networks without many of the disadvantages of VPNs. First and foremost, any device that has a wireless radio, e.g. the wireless client 28, also has the ability to securely connect without requiring any additional software, i.e. using existing IEEE 802.11 standards for secure communications. Many if not most types of devices today are built with one or more wireless radios embedded including laptops, cell phones, PDAs, tablets, netbooks, and many others. Additionally, the logon process can be automatic, instantaneous, and secure. These qualities are in strong contrast with the disadvantages of VPNs. The introduction of IEEE 802.11i and Advanced Encryption Standard (AES) encryption along with the use of IEEE 802.1X authentication has significantly strengthened the security of wireless networks and puts them at par or better than a typical VPN. Additionally, digital signature/certificate-based authentication is much more widely accepted on wireless networks than on it has been on VPNs. Digital signature authentication is the strongest form of available.

As described herein, currently wireless clients 28 that wish to establish a secure connection to the remote network 24 must use additional software and/or browser components to identify the remote network 24, authenticate themselves, and ensure the confidentiality and integrity of data while traversing insecure networks, such as the Internet 16. The use of these additional software components makes establishing the secure connection difficult or time consuming. Also, these additional software components are not readily available for every computing platform. Conversely, there is no additional software required when establishing a secure connection to a wireless network. The introduction of IEEE 802.11i and AES encryption along with the use of IEEE 802.1X authentication makes wireless network security very strong. Unfortunately, wireless networks are today operated solely for access to a single network or for general access to the Internet 16. Although most devices are natively capable of logging onto a wireless network, most operators employ a logon process that requires manual interaction. This manual interaction is not possible on every wireless client 28 (e.g., smart phone or regular cell phone) and is so cumbersome that users often will forgo connectivity.

The present invention includes various modifications in wireless infrastructure products such as the AP 26, wireless switches/controllers, etc., i.e. collectively referred to as the wireless network proxy, to enable secure remote access between the client 28 and the remote network 24. By modifying the way that wireless networks work through the present invention, it is possible to use wireless from any wireless client 28 to obtain direct, secure connectivity to the remote network 24 and eliminate the need for manual interaction during logon. The wireless infrastructure AP 26 and wireless switches/controllers can be modified to respond to requests for multiple networks and establish secure connections directly from the client 28 to the remote network 24, e.g. over the Internet 16 to the wireless network gateway 34. Advantageously, no modifications to wireless client 28 devices are required; the wireless client 28 uses the typical WLAN supplicant for connectivity and can be unaware of the wireless network proxy's activity is setting up an end-to-end connection from the client 28 to the remote network 24. This enables the solution to work across a wide variety of devices, e.g. phones, PDAs, mini-computers, laptops, etc., given that no special software or browser components are required. The present invention enables secure connectivity to remote networks, such as the remote network 24, on demand and without requiring an interactive logon. Extending wireless networks to enable access from remote locations eliminates the disadvantages of VPNs while leveraging all of the significant advantages of modern wireless networks. To accomplish this, modifications are required to the wireless infrastructure; however, no modifications are required on client devices that desire access.

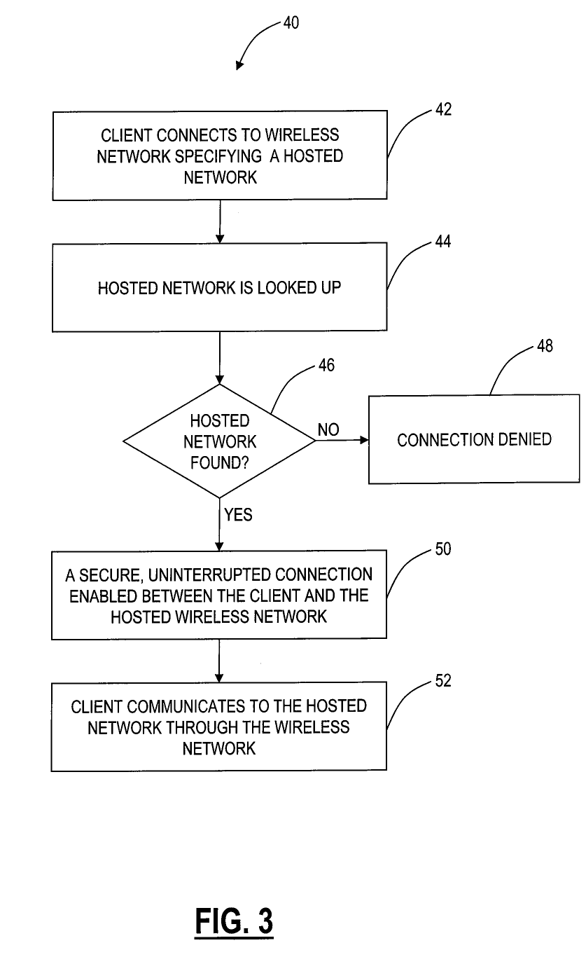

Referring to FIG. 3, a flowchart illustrates a wireless network access process 40 for connecting a hosted wireless network from a remote wireless network according to an exemplary embodiment of the present invention. The present invention enables wireless network proxies such as wireless infrastructure products to provide access beyond the network on which they operate. To extend wireless networks to remote locations, the wireless network proxies at the wireless network 22 must respond to requests for multiple networks, such as the remote network 24. For example, today at a typical hotspot, a user must request to connect to the “hotspot” network name to gain access. In the present invention, a wireless network proxy at the hotspot, i.e. the wireless network 22, will need to respond to both the “hotspot” network name and the network names of any hosted wireless networks, e.g. the remote network 24. Alternatively, the wireless network proxy will only need to respond to the names of any hosted wireless networks. If the user typically connects to the “CompanyA” network name and that company operates a hosted wireless network, the hotspot would have to respond when the end-user's laptop requests the “CompanyA” network name (step 42). For example, a client device may include software that allows for specification of both the wireless network and a remote hosted wireless network. Alternatively, the client device can be configured to input the remote hosted wireless network through a web browser interface or the like. Additionally, the client device can solely designate the name of the remote hosted network with the wireless network proxy realizing this is a request for a hosted network, such as through a look-up process, etc.

The present invention adds support for the lookup of hosted wireless networks, such as through a look up server or a public DNS server. The wireless infrastructure products in the wireless network are able to determine when a requested network name is that of a hosted wireless network, e.g. “CompanyA” network name. The wireless network proxy is configured to reference a site that lists hosted wireless networks and their associated wireless network gateway(s), i.e. the wireless network looks up the hosted network (step 44). If the network name requested by the end-user is that of a hosted wireless network, the wireless network proxy knows to respond to the network name and how to direct the connectivity request when received. This lookup can be done on a proprietary lookup network (e.g., through the lookup server 38) as well as the public domain name server (DNS) infrastructure as this technology is more widely adopted, i.e. integration of remote hosted networks in the public DNS infrastructure. If the wireless network fails to find the hosted network (step 46), access can be denied (step 48). Additionally, a message can be provided that the hosted wireless network was not found and an opportunity for the user to reenter the name and/or to retry to find the hosted wireless network.

If the wireless network finds the hosted network through the lookup (step 46), the wireless network enables a secure, uninterrupted connection to hosted wireless network (step 50). The wireless network proxy at the wireless network allows the end-user's device to establish encryption keys with the wireless network gateway of the hosted wireless network. However, the wireless network proxy itself does not know the encryption keys in use. The wireless client operates as it always would; no modifications are made to the wireless client (step 52). Specifically, the wireless client can utilize IEEE 802.11i (Wi-Fi Protected Access—WPA and WPA2), AES encryption, extensible authentication protocol (EAP), and IEEE 802.1X, Wired Equivalent Privacy (WEP), etc. authentication to communicate with the wireless network proxy and through to the wireless network gateway. Specifically, the wireless network proxy enables whatever wireless security is utilized by the client to be extended to the wireless network gateway. This can include encapsulating the wireless security over another protocol, e.g. wired protocols, etc. to the wireless network gateway. From the wireless client's perspective, it is in a wireless connectivity relationship with the hosted network through the wireless network gateway, i.e. the wireless security (whatever is being used) extends from the wireless client to the wireless network gateway. The wireless network proxy is responsible for providing this functionality.

Referring back to FIG. 2, the remote network 34, i.e. the hosted wireless network, includes the wireless network gateway 34. The remote network 34 operates one or more wireless network gateways 34 that terminate data connections from wireless clients connecting from the wireless network. Specifically, the client 28 and the wireless network gateway 34 via the AP 26 are configured to create a secure, uninterrupted connection over the Internet 16 (or another network). In an exemplary embodiment, the secure connection can be a secure tunnel similar to a VPN, but the creation and maintenance of the tunnel is done solely by the AP 26 between the wireless client 28 and the wireless network gateway 34. In an exemplary embodiment, this secure connection between the client 28 and the gateway 34 includes IEEE 802.11i protocols, etc. that are utilized over a wireless connection between the client 28 and the AP 26 and then encapsulated by the AP 26 between the AP 26 and the gateway 34. In an alternative embodiment, the AP 26 can create other secure tunnels such as with point-to-point tunneling protocol (PPTP), layer 2 tunneling protocol (L2TP), Internet Protocol Security (IPsec), Secure Sockets Layer (SSL)/Transport Layer Security (TLS), and the like. In this alternate embodiment, the client 28 operates normally over the wireless network 22 utilizing standard IEEE 802.11 protocols that operate with any existing wireless device and uses this other secure tunnel to communicate with the gateway 34. In either of these exemplary embodiments, the wireless network gateway 34 is responsible for authenticating users, decrypting data, and forwarding data to the remote network 24. The wireless network gateway 34 can operate within the hosted wireless network or on behalf of the hosted wireless network at a separate physical location.

Also, wireless infrastructure products, such as the AP 26, at the remote wireless network 22 can be capable of tracking logons and usage by the wireless client 28 including information about the requested remote network 24 or other hosted wireless networks. This tracking can be used for the purposes of billing on a per-logon basis, an amount of time basis, an amount of data basis, or any other popular methods of usage tracking. The wireless network gateway 34 at the remote network 24 can also be capable of tracking logon and usage by the wireless client 28 including information about the wireless network 22 from which they connected. The tracking can be verifiable by each party involved. Additionally, the wireless network 22 can have the ability to publish the services at their locations to which the wireless client 28 has access. For example, if the wireless client 28 is connected from a hotspot in a library but wants to print to a printer in the library, the printer should be published as a local service. This requires that the wireless network gateway 34 establish a secure connection to the wireless network 22 for the purpose of accessing only the published services.

The present invention contemplates the wireless client 28 being able to request any remote hosted network from the AP 26. The AP 26 is configured to act as a wireless network proxy performing a look up of the remote hosted network and establishment of a secure end-to-end connection between the client 28 and the remote hosted network. This secure end-to-end connection includes can use multiple formats and protocols, but underlying the connection is the secure wireless protocols. For example, the secure end-to-end connection includes a wireless connection from the client 28 to the AP 26 on the wireless network 22 and a connection that encapsulates the wireless security of the client 28 between the AP 26 and the gateway 34. This process is transparent to the client 28 which is configured to operate normally using standard IEEE 802.11 protocols to communicate to the remote hosted network through the wireless network gateway. Effectively, the wireless network gateway 34 becomes a virtual remote AP to the client 28.

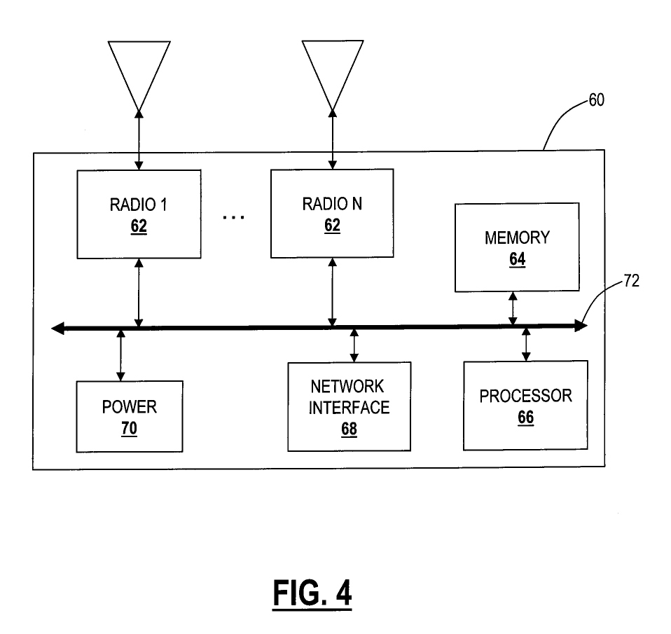

Referring to FIG. 4, a wireless infrastructure access device 60 is illustrated according to an exemplary embodiment of the present invention. The wireless infrastructure access device 60 can include a wireless AP, wireless switch/controller, thin AP, and the like. In general, the wireless device 60 is configured to provide secure wireless access to various wireless client devices, such as the wireless client 28 in FIG. 2. Further, the wireless device 60 is configured to implement secure remote access to a hosted network by looking up the hosted network and creating a secure connection to the hosted network, i.e. the wireless network proxy functionality. As described herein, the wireless device 60 enables the wireless network 22. In an exemplary embodiment, the wireless device 60 can include, without limitation: one or more radios 62, memory 64, a processor 66, a network interface 68, and a power source 70. The elements of wireless device 60 can be interconnected together using a bus 72 or another suitable interconnection arrangement that facilitates communication between the various elements of wireless device 60. It should be appreciated that FIG. 4 depicts the wireless device 60 in an oversimplified manner and a practical embodiment can include additional components and suitably configured processing logic to support known or conventional operating features that are not described in detail herein.

The radios 62 enable wireless communication to a plurality of wireless clients, such as the wireless client 28. The wireless device 60 can include more than one radio 62, e.g., each wireless radio 62 can operate on a different channel (e.g., as defined in IEEE 802.11). In an exemplary embodiment, the wireless device 60 contains intelligence and processing logic that facilitates centralized control and management of WLAN elements, including wireless client devices associated with device 60. In an exemplary embodiment, one wireless device 60 can support any number of wireless client devices (limited only by practical considerations). Thus, the wireless device 60 can serve multiple wireless access devices, which in turn can serve multiple mobile devices. The wireless device 60 is suitably configured to transmit and receive data, and it can serve as a point of interconnection between a WLAN and a fixed wire (e.g., Ethernet) network. In practice, the number of wireless device 60 in a given network may vary depending on the number of network users and the physical size of the network.

The memory 64 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 64 can incorporate electronic, magnetic, optical, and/or other types of storage media. Note that the memory 64 can have a distributed architecture, where various components are situated remotely from one another, but can be accessed by the processor 66. The processor 66 with the memory 64 generally represents the hardware, software, firmware, processing logic, and/or other components of the wireless device 60 that enable bi-directional communication between the wireless device 60 and network components to which wireless device 60 is coupled. The processor 66 can be any microprocessor, application specific integrated circuit (ASIC), field programmable gate array (FPGA), digital signal processor (DSP), any suitable programmable logic device, discrete gate or transistor logic, discrete hardware components, or combinations thereof that has the computing power capable of managing the radios 64 and the auxiliary components of the device 60. For example, referring to FIG. 2, the processor 66 and the memory 64 is suitably configured to have the device 60, i.e. the AP 26, communicate with components on the wireless network 22, such as the wireless client device 28 and/or the networks 22, 24. The wireless device 60 also includes the network interface 68 that can provide an Ethernet interface (i.e., wired) or another radio (i.e., wireless) such that wireless device 60 can communicate with a external network, such as the Internet 16 in FIG. 2.

In an exemplary embodiment, the wireless device 60 can support one or more wireless data communication protocols that are also supported by the wireless network infrastructure. Any number of suitable wireless data communication protocols, techniques, or methodologies can be supported by wireless device 60, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. In an exemplary embodiment, the wireless device 60 is preferably compliant with at least the IEEE 802.11 specification and configured to receive association requests via access devices coupled to the wireless switch 200, as described below. Further, the wireless device 60 includes a suitable power 70 source such as an alternating current (AC) interface, direct current (DC) interface, power over Ethernet (PoE) compatible interface, or a repository for one or more disposable and/or rechargeable batteries.

As described in FIGS. 2 and 3, the wireless device 60 is a wireless network proxy that has been modified to enable secure, remote access to hosted wireless networks. For example, the wireless device 60 can be configured to perform the functionality associated with wireless network access in FIG. 3. In an exemplary embodiment, the processor 66 and the memory 64 are configured to perform a lookup of a hosted wireless network responsive to a client request and to provide a secure end-to-end connection through the network interface 68 for the client to the hosted wireless network, i.e. through encapsulating the wireless security protocols in whatever format is used by the device to communicate to the hosted wireless network. This functionality is solely implemented within the wireless device 60 and is transparent to the client. Thus, the client requires no modification to support secure remote access to the hosted wireless network through the wireless device 60. The client utilizes already associated with the wireless device 60, such as IEEE 802.11i, AES encryption, and IEEE 802.1x, WPA, WEP, etc., to communicate securely with the wireless device 60. Note, the wireless device 60 can be configured to extend the IEEE 802.11i, AES encryption, and IEEE 802.1x, WPA, WEP, etc. to the hosted wireless network. Alternatively, the wireless device 60 can establish a secure tunnel to the hosted network and terminate that tunnel at the wireless network gateway. Accordingly, this provides similar functionality to conventional VPNs without requiring software or the like on the client device.

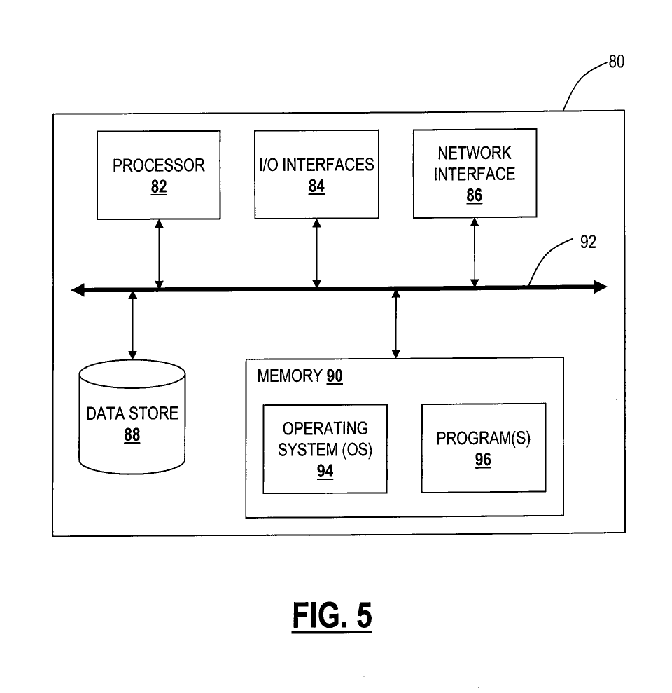

Referring to FIG. 5, a server 80 is illustrated according to an exemplary embodiment of the present invention. As described herein, the server 80 can be the lookup server, the wireless network gateway, and the like. The server 80 can be a digital computer that, in terms of hardware architecture, generally includes a processor 82, input/output (I/O) interfaces 84, a network interface 86, a data store 88, and memory 90. The components (82, 84, 86, 88, and 90) are communicatively coupled via a local interface 92. The local interface 92 can be, for example but not limited to, one or more buses or other wired or wireless connections, as is known in the art. The local interface 92 can have additional elements, which are omitted for simplicity, such as controllers, buffers (caches), drivers, repeaters, and receivers, among many others, to enable communications. Further, the local interface 92 can include address, control, and/or data connections to enable appropriate communications among the aforementioned components.

The processor 82 is a hardware device for executing software instructions. The processor 82 can be any custom made or commercially available processor, a central processing unit (CPU), an auxiliary processor among several processors associated with the server 80, a semiconductor-based microprocessor (in the form of a microchip or chip set), or generally any device for executing software instructions. When the server 80 is in operation, the processor 82 is configured to execute software stored within the memory 90, to communicate data to and from the memory 90, and to generally control operations of the server 80 pursuant to the software instructions. The I/O interfaces 84 can be used to receive user input from and/or for providing system output to one or more devices or components. User input can be provided via, for example, a keyboard and/or a mouse. System output can be provided via a display device and a printer (not shown). I/O interfaces 84 can include, for example, a serial port, a parallel port, a small computer system interface (SCSI), an infrared (IR) interface, a radio frequency (RF) interface, and/or a universal serial bus (USB) interface.

The network interface 86 can be used to enable the server 80 to communicate on a network. For example, the server 80 can utilize the network interface 88 to communicate to with remote networks, such as a wireless network, a hosted wireless network, and the like. The network interface 86 can include, for example, an Ethernet card (e.g., 10BaseT, Fast Ethernet, Gigabit Ethernet) or a wireless local area network (WLAN) card (e.g., 802.11a/b/g). The network interfaces 86 can include address, control, and/or data connections to enable appropriate communications on the network. A data store 88 can be used to store data. The data store 88 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 88 can incorporate electronic, magnetic, optical, and/or other types of storage media. In one example, the data store 88 can be located internal to the server 90 such as, for example, an internal hard drive connected to the local interface 92 in the server 80. Additionally in another embodiment, the data store can be located external to the server 80 such as, for example, an external hard drive connected to the I/O interfaces 84 (e.g., SCSI or USB connection). Finally in a third embodiment, the data store may be connected to the server 80 through a network, such as, for example, a network attached file server.

The memory 90 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 90 may incorporate electronic, magnetic, optical, and/or other types of storage media. Note that the memory 90 can have a distributed architecture, where various components are situated remotely from one another, but can be accessed by the processor 82. The software in memory 90 can include one or more software programs, each of which includes an ordered listing of executable instructions for implementing logical functions. In the example of FIG. 5, the software in the memory system 90 includes a suitable operating system (O/S) 94 and programs 96. The operating system 94 essentially controls the execution of other computer programs, and provides scheduling, input-output control, file and data management, memory management, and communication control and related services. The operating system 94 can be any of Windows NT, Windows 2000, Windows XP, Windows Vista (all available from Microsoft, Corp. of Redmond, Wash.), Solaris (available from Sun Microsystems, Inc. of Palo Alto, Calif.), or LINUX (or another UNIX variant) (available from Red Hat of Raleigh, N.C.).

In the present invention, the server 80 can represent the internal network devices 32, the wireless network gateway 34, and the lookup server 38 from FIG. 2. The programs 96 can include a software component configured to interact with the wireless access device 60 of FIG. 4 to create a secure connection or tunnel responsive to a request for remote access from the wireless client 28. In the case of the lookup server 38, the programs 96 can include a database that provides addressing of various remote hosted wireless networks in which the client can connect to. In this scenario, the wireless device 60 can query the lookup server responsive to a client request to find a hosted wireless network.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A network, comprising:
a local wireless network comprising a wireless network proxy;
a hosted network connected through an external network to the wireless network proxy; and
a wireless client;
wherein the wireless network proxy is configured to enable a secure connection from the wireless client to the hosted network providing access for the wireless client to the hosted network.

2. The network of claim 1, wherein the wireless client communicates to the hosted network through the secure connection comprising any of IEEE 802.11i, AES encryption, and IEEE 802.1x, WPA, WPA2, TKIP, and WEP.

3. The network of claim 2, wherein the wireless proxy, responsive to a request from the client, encapsulates security credentials of the client and sends them to the hosted network over the external network.

4. The network of claim 1, further comprising a lookup server connected to the wireless network proxy, wherein the lookup server comprises a directory of a plurality of hosted networks including the hosted network.

5. The network of claim 2, further comprising:
a wireless network gateway in the hosted network;
wherein the wireless network proxy serves as an intermediary between the wireless network gateway and the wireless client to enable the secure tunnel through the external network.

6. The network of claim 5, wherein the wireless network gateway is configured to authenticate the wireless client, decrypt data from the wireless client, and forward decrypted data to the hosted network.

7. The network of claim 5, wherein the wireless network gateway and the wireless network proxy are configured to gather statistics relates to the wireless client and the hosted network, and wherein the wireless network gateway and the wireless network proxy are further configured to update the statistics to a centralized accounting system.

8. The network of claim 5, wherein the wireless network gateway is configured to publish local services on the local wireless network through a secure connection.

9. The wireless network of claim 3, wherein the secure connection comprises encryption between the wireless client and the hosted network and with the wireless network proxy is unaware of keys associated with the encryption.

10. The wireless network of claim 9, wherein the wireless client comprises a device compliant to IEEE 802.11 protocols, and wherein the wireless client communicates normally on the local wireless network with the wireless network proxy and wireless network gateway forming the secure connection.

11. The wireless network of claim 9, wherein the wireless network gateway comprises a virtual access point and the wireless client associates with the virtual access point.

12. A wireless infrastructure device, comprising:
a radio connected to a local wireless network;
a backhaul network interface connected to an external network;
a processor; and
a local interface communicatively coupling the radio, the backhaul network interface, and the processor;
wherein the radio, the backhaul network interface, and the processor are collectively configured to:
receive association requests from a wireless client, wherein the association requests comprise a request to access a remote network; and
enable a secure connection through the backhaul network interface to the remote network such that the wireless client can securely access the remote network.

13. The wireless infrastructure device of claim 12, wherein the radio, the backhaul network interface, and the processor are further configured to look up the remote network through one of a look up server and a public domain name server.

14. The wireless infrastructure device of claim 12, wherein the radio, the backhaul network interface, and the processor are further configured to enable the secure transmission of data from the wireless client to a wireless network gateway in the remote network.

15. The wireless infrastructure device of claim 14, wherein the wireless network gateway is configured to receive the data from the wireless client and to authenticate the wireless client, decrypt data from the wireless client, and forward decrypted data to devices in the remote network.

16. The wireless infrastructure device of claim 15, wherein the radio, the backhaul network interface, and the processor are further configured to receive published local services from the wireless network gateway.

17. The wireless infrastructure device of claim 12, wherein the radio, the backhaul network interface, and the processor are further configured to gather statistics relates to the wireless client and the remote network.

18. A remote wireless access method, comprising:
in a wireless network, receiving an association request from a client comprising a request to access a hosted network;
enabling a secure connection from the client to the hosted network; and
acting as a proxy between the client and the hosted network to securely transmit data between the client and the hosted network.

19. The remote wireless access method of claim 18, further comprising:
looking up the hosted network responsive to the association request and prior to enabling the secure connection.

20. The remote wireless access method of claim 18, wherein the data received from the client over the wireless network is secure through a wireless network security mechanism and wherein the data in thereafter transmitted encapsulating the wireless network security mechanism to the hosted network.
